(19) United States
(12) Patent Application Publication
(10) Pub. No.: US 2021/0134102 A1
(43) Pub. Date: May 6, 2021

(54) MONEY DEPOSITING/DISPENSING APPARATUS, MONEY HANDLING SYSTEM, AND MONEY HANDLING METHOD

(71) Applicant: Glory Ltd., Himeji-shi (JP)

(72) Inventors: Yang CHEN, Himeji-shi (JP); Kazuhiro DOI, Himeji-shi (JP); Kazutoshi NAKAGAWA, Himeji-shi (JP); Keiju NAKAGAWA, Himeji-shi (JP)

(73) Assignee: Glory Ltd., Himeji-shi (JP)

(21) Appl. No.: 17/080,887

(22) Filed: Oct. 27, 2020

(30) Foreign Application Priority Data
Oct. 30, 2019 (JP) 2019-197275

(51) Int. Cl. G07D 11/245; G07D 11/18; G07D 1/06

(52) U.S. Cl. CPC G07D 11/245; G07D 11/18; G07D 2201/00; G07D 2211/00; G07D 1/06

(57) ABSTRACT

A money depositing/dispensing apparatus including a first storage configured to store therein money for each denomination; a second storage configured to store therein money in a denomination mixed state; a third storage configured to store therein money such that the money cannot be fed out therefrom; a transport configured to move money between the storages; and circuitry configured to perform control such that predetermined money is moved from the second storage to the third storage in a case that the first storage needs to be replenished with money, and determine a denomination and a quantity of money for replenishment, based on a storage quantity of money in the second storage after the movement and on a storage quantity of money in the first storage.

### CROSS REFERENCE TO RELATED APPLICATION

The present application is based on and claims priority to Japanese Patent Application No. 2019-197275 filed on Oct. 30, 2019. The entire disclosure of the above-identified application, including the specification, drawings and claims is incorporated herein by reference and its entirety.

### TECHNICAL FIELD

The present disclosure relates to a money depositing/dispensing apparatus, a money handling system, and a money handling method configured to execute a money replenishment process.

### BACKGROUND ART

Conventionally, a money handling apparatus that executes a money replenishment process and a money handling system including the money handling apparatus have been used. For example, the money handling system includes one or more money handling apparatuses, and a management server that manages the respective money handling apparatuses. The money handling apparatus executes a depositing process, and stores deposited money in a storage unit. Meanwhile, the money handling apparatus executes a dispensing process of dispensing money that has been stored in the storage unit. When money in the storage unit becomes insufficient, the money handling apparatus cannot execute the dispensing process. Therefore, the money replenishment process needs to be executed before such insufficiency of money occurs in the storage unit.

For example, Japanese Patent No. 3434906 discloses a system that manages the storage state of money in a money handling apparatus and notifies a user of the apparatus of insufficiency of money. Meanwhile, Japanese Patent No. 4452109 discloses a system that manages both a money handling apparatus to be replenished with money as a destination of the money and a money handling apparatus that dispenses the money as a source of the money such that, when a storage quantity of money in the apparatus of the destination decreases and reaches a predetermined quantity, money is dispensed from the apparatus of the source for replenishment. In this system, for example, money with which a change handling machine needs to be replenished and money to be dispensed from a cash handling machine to replenish the change handling machine are managed, whereby money not to be used for replenishment of the change handling machine is prevented from being dispensed from the cash handling machine when the money replenishment process is executed.

Japanese Patent No. 5902667 discloses a money handling apparatus provided with a cassette detachably mounted thereto. The cassette can be used for replenishing a money handling apparatus with money. After money for replenishment is stored in a cassette mounted to a money handling apparatus as a source of money, the cassette is removed and mounted to a money handling apparatus as a destination of money. The money handling apparatus as a destination of money can feed out the money from the mounted cassette and replenish a storage unit with the fed out money.

### SUMMARY

In the conventional arts described above, however, the money replenishment process is not efficiently executed in some cases. For example, although the money handling apparatus disclosed in Japanese Patent No. 5902667 includes a collection unit that is a storage unit for storing money such that the stored money cannot be fed out, the available storage capacity of the collection unit is not considered for the replenishment process.

The present disclosure is made in view of the aforementioned problem, as well as the other problems, of the conventional arts, and the present disclosure addresses these issues, as discussed herein, with a money depositing/dispensing apparatus, a money handling system, and a money handling method capable of realizing efficient replenishment of money.

In order to solve the above problem and other problems, a money depositing/dispensing apparatus includes: a denomination-based storage unit configured to store therein money for each denomination; a mixture storage unit configured to store therein money in a denomination mixed state; a collection storage unit configured to store therein money such that the money cannot be fed out therefrom; a transport unit configured to move money between the storage units; and a control unit configured to perform control such that predetermined money is moved from the mixture storage unit to the collection storage unit when the denomination-based storage unit needs to be replenished with money, and to determine denominations and quantities of money with which the denomination-based storage unit and the mixture storage unit are replenished, based on a storage quantity of money in the mixture storage unit after the movement and on a storage quantity of money in the denomination-based storage unit.

### BRIEF DESCRIPTION OF THE DRAWINGS

FIG. 1 is a schematic diagram showing a money depositing/dispensing apparatus according to an embodiment;

FIG. 2 is a block diagram schematically showing a functional configuration of the money depositing/dispensing apparatus;

FIG. 3 shows an exemplary configuration of a money handling system according to the embodiment;

FIG. 4 shows storage states of money in the money depositing/dispensing apparatus and a money depositing apparatus at the start of business hours of a store;

FIG. 5 illustrates an example of a method of moving money from a money depositing apparatus that needs collection of money to the money depositing/dispensing apparatus;

FIG. 6 illustrates an example of a method of moving money from the money depositing apparatus to the money depositing/dispensing apparatus that needs replenishment with money;

FIGS. 7A and 7B illustrate examples of changes in the quantity of money before and after a replenishment process executed in the money depositing/dispensing apparatus;

FIGS. 8A and 8B illustrate examples of notification screens displayed on an operation/display unit of the money depositing/dispensing apparatus;

FIGS. 9A and 9B illustrate examples of screens indicating collection results, displayed on the operation/display unit of the money depositing/dispensing apparatus;

FIG. 10 illustrates an example of a screen displayed on the operation/display unit after completion of a collection process to increase the available storage capacity of a cassette; and

FIG. 11 illustrates an example of a screen displayed on the operation/display unit of the money depositing apparatus.

### DESCRIPTION OF EMBODIMENTS

Hereinafter, a money depositing/dispensing apparatus, a money handling system, and a money handling method according to the present disclosure will be described with reference to the drawings. The money depositing/dispensing apparatus according to the present disclosure is a money handling apparatus that can executes a depositing process of money and a dispensing process of the money, i.e., at least either banknotes or coins.

The money handling system according to the present disclosure includes one or more money depositing/dispensing apparatuses according to the present disclosure. The kinds and number of the money handling apparatuses included in the money handling system are not particularly limited. For example, the money handling system may include one or more money depositing/dispensing apparatuses different from the money depositing/dispensing apparatus of the present disclosure, or may include one or more money depositing apparatuses that execute only a depositing process.

In this embodiment, for ease of description, the money handling system includes the money depositing/dispensing apparatus of the present disclosure and a money handling apparatus for a depositing process which is different from the money depositing/dispensing apparatus of the present disclosure. Hereinafter, a money handling apparatus other than the money depositing/dispensing apparatus of the present disclosure is referred to as a “money depositing apparatus”, and a case where these apparatuses are installed in a retail store will be described.

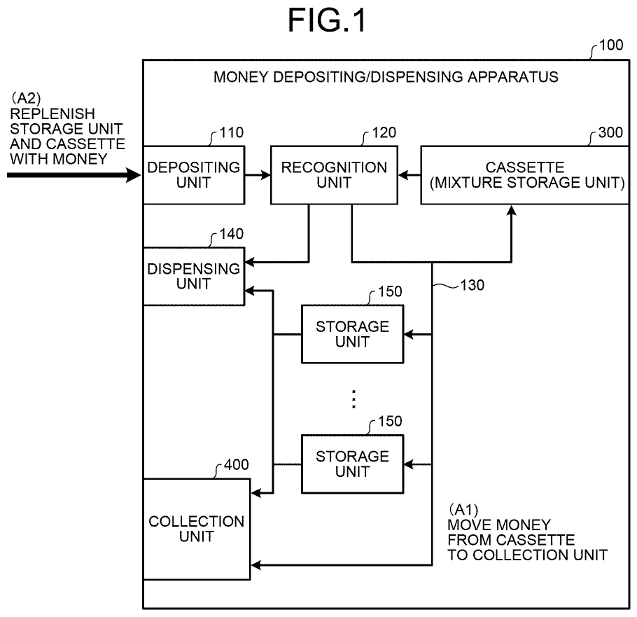

Firstly, the money depositing/dispensing apparatus according to the present embodiment is described. FIG. 1 is a schematic diagram illustrating a money depositing/dispensing apparatus 100 according to the present embodiment. The money depositing/dispensing apparatus 100 is installed at a checkout counter of a store and used for checkout when a transaction is made between a customer and the store. The money depositing/dispensing apparatus 100 executes a depositing process for money received from the customer, and a dispensing process for change to be returned to the customer. In the depositing process, the money depositing/dispensing apparatus 100 receives money in a depositing unit 110, recognizes and counts the money by a recognition unit 120, and stores the money by denomination in a plurality of storage units 150. In the dispensing process, money of each denomination to be dispensed is fed out from the corresponding storage unit 150 and discharged into a dispensing unit 140. Each storage unit 150 is a denomination-based storage unit which stores therein money of the corresponding denomination such that the money can be fed out therefrom. Money is transported by a transport unit 130. The transport unit 130 transports the money along a transport path connecting the respective units as shown in FIG. 1. The money depositing/dispensing apparatus 100 manages the denominations of money and the quantity of money for each denomination stored in each storage unit 150.

A cassette 300 is a mixture storage unit that stores therein a plurality of denominations of money in a denomination mixed state such that the money can be fed out therefrom. The cassette 300 is detachable from the money depositing/dispensing apparatus 100. The money depositing/dispensing apparatus 100 executes a replenishment process by using the money stored in the cassette 300 so as to overcome a shortage of money in any of the storage units 150. In the replenishment process, the money depositing/dispensing apparatus 100 feeds out money from the cassette 300, and recognizes and counts the money by the recognition unit 120. When the recognized money is money to be used for replenishment, this money is stored in the corresponding storage unit 150. When the recognized money is money not to be used for replenishment, this money is returned to and stored in the cassette 300. The money depositing/dispensing apparatus 100 manages the denominations of money and the quantity of money for each denomination stored in the cassette 300.

A collection unit 400 stores therein money to be collected from the money depositing/dispensing apparatus 100. While the storage units 150 and the cassette 300 each perform storage of money and feeding-out of the stored money, the collection unit 400 performs only storage of money and does not perform feeding-out of money. The collection unit 400 is a collection storage unit that stores therein a plurality of denominations of money in a denomination mixed state such that the money cannot be fed out therefrom. The money depositing/dispensing apparatus 100 manages the denominations of money and the quantity of money for each denomination stored in the collection unit 400.

When insufficiency of money occurs in any storage unit 150, the money depositing/dispensing apparatus 100 can replenish the storage unit 150 with money fed out from the cassette 300, and/or money received in the depositing unit 110.

When executing the replenishment process by using the money received in the depositing unit 110, the money depositing/dispensing apparatus 100 executes a collection process of collecting, into the collection unit 400, at least a part of the money being stored in the cassette 300 as shown in FIG. 1 (A1). After the quantity of money storable in the cassette 300 is increased through the collection process, the money depositing/dispensing apparatus 100 replenishes the storage unit 150 and the cassette 300 with the money received in the depositing unit 110 (A2). The money depositing/dispensing apparatus 100 replenishes the storage unit 150 with money to make up for the insufficiency of money, and replenishes the cassette 300, whose available storage capacity has been increased, with money that can be used for future replenishment of the storage unit 150.

Based on a collection setting prepared in advance, the money depositing/dispensing apparatus 100 determines the denominations of money and the quantity of money for each denomination to be collected from the cassette 300 into the collection unit 400. The collection setting allows a user of the money depositing/dispensing apparatus 100 to set the denominations of money to be collected and the quantity of money to be collected for each denomination. For example, in a case where the cassette 300 stores coins of 1-JPY, 5-JPY, 10-JPY, 50-JPY, 100-JPY and 500-JPY, for replenishment of the storage unit 150, the user can prepare the collection setting so as to collect coins of 5-based denominations (5-JPY coin, 50-JPY coin and 500-JPY coin) each by 50 pieces. For another example, the user can prepare the collection setting so as to collect coins of each of the 5-based denominations by 10% of the number of coins of each denomination being stored in the cassette 300.

When coins of the 5-based denominations are to be dispensed from the money depositing/dispensing apparatus 100, it is possible to perform a substitute dispensing process in which the monetary amount of coins of the 5-based denominations is dispensed by coins of 1-based denominations (1-JPY coin, 10-JPY coin, and 100-JPY coin). For example, after the coins of the 5-based denominations are collected from the cassette 300 into the collection unit 400 and an empty space is formed in the cassette 300, this space is used to store coins of the 1-based denominations that can be used for a dispensing process of coins of the 1-based denominations and a substitute dispensing process for coins of the 5-based denominations.

The user can prepare the collection setting, such that the money depositing/dispensing apparatus 100 determines the denominations of money to be collected and the quantity of money to be collected for each denomination, based on increase/decrease tendency of money in the money depositing/dispensing apparatus 100. By using the collection setting, the user can set the money depositing/dispensing apparatus 100 so as to collect, into the collection unit 400, money of one or more denominations in order from a denomination of which the decreasing pace of the number of pieces of money (quantity of money) is the lowest pace in the money depositing/dispensing apparatus 100. Also, by using the collection setting, the user can set the number of pieces of money (quantity of money) of each denomination to be collected into the collection unit 400. In other words, the user can prepare the collection setting such that money of a denomination of which the decreasing pace of the number of pieces of money (quantity of money) is a fast pace is not collected into the collection unit 400 which cannot feed out stored money, but is left in the cassette 300.

For example, the user can prepare the collection setting such that the denomination of money to be collected and the quantity of money to be collected for each denomination are determined based on the denominations of money and the quantity of money for each denomination that decreases in the cassette 300 within a predetermined time period, i.e., money with which the storage unit 150 is replenished. For example, the user can prepare the collection setting so as to compare the decreased number of pieces of money (decreased quantity of money) for each denomination in the cassette 300 within 1 hour immediately before the collection process and to collect, from the cassette 300, 50 pieces of money of a denomination having the smallest decreased number. Alternatively, the user can prepare the collection setting so as to collect, from the cassette 300, 10% of the number of pieces of money (quantity of money) of the denomination having the smallest decreased number.

For another example, the user can prepare the collection setting such that the money depositing/dispensing apparatus 100 determines the denomination of money to be collected and the quantity of money to be collected for each denomination, based on a change during a predetermined time period in the number of pieces of money (quantity of money) stored in each storage unit 150. For example, the user can prepare the collection setting so as to compare the decreased number of pieces of money (decreased quantity of money) for each denomination in the storage units 150 within 1 hour immediately before the collection process and to collect, from the cassette 300, 50 pieces of money of a denomination having the smallest decreased number. Alternatively, the user can prepare the collection setting so as to collect, from the cassette 300, 10% of the number of pieces of money (quantity of money) of the denomination having the smallest decreased number.

Thus, by preparing the collection setting such that money of a denomination that decreases at a low pace in the money depositing/dispensing apparatus 100 is collected from the cassette 300 into the collection unit 400, a space formed in the cassette 300 by the collection can be used to store money of a denomination that decreases at a fast pace.

The number of denominations selected by the collection setting as targets of the collection is not particularly limited. One denomination may be selected, or a plurality of denominations may be selected. Likewise, the number of pieces of money (quantity of money) to be collected is not particularly limited, and can be changed by the collection setting. As for the number of pieces of money to be collected, the same number may be set for all the denominations, or different numbers may be set for the respective denominations.

During the replenishment process, the money depositing/dispensing apparatus 100 replenishes, with money, the storage unit 150 in which insufficiency of money occurs and the cassette 300 whose available storage capacity has been increased through the collection process. Based on information about money being stored in the storage unit 150, the money depositing/dispensing apparatus 100 specifies the denomination of money insufficient in the storage unit 150 and the quantity of money for each denomination, and determines the denomination of money for replenishment and the quantity of money for the replenishment for each denomination to solve the insufficiency. Furthermore, based on information about money left in the cassette 300 after the collection process and on replenishment setting prepared in advance, the money depositing/dispensing apparatus 100 determines the denominations of money and the quantity of money for each denomination, with which the cassette 300 is to be replenished. The money depositing/dispensing apparatus 100 receives, in the depositing unit 110, the determined quantity of money of the determined denominations, and replenishes the storage unit 150 and the cassette 300 with the received money. The replenishment setting and the replenishment process will be described later.

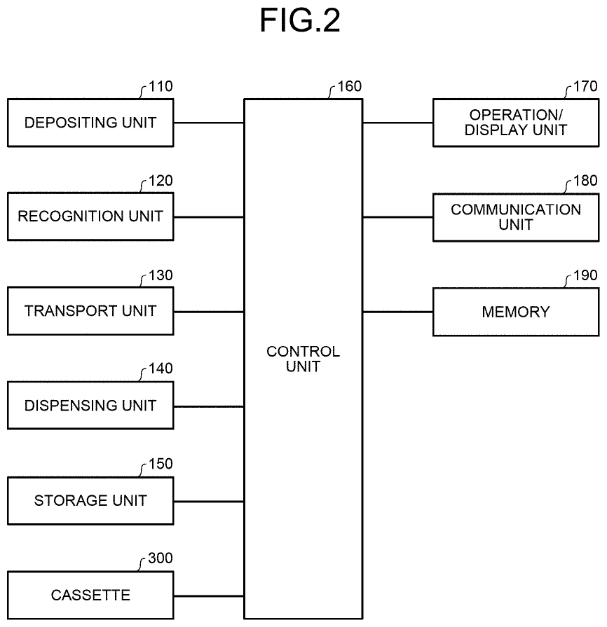

FIG. 2 is a block diagram schematically showing a functional configuration of the money depositing/dispensing apparatus 100. As shown in FIG. 2, the money depositing/dispensing apparatus 100 includes a control unit 160, an operation/display unit 170, a communication unit 180, and a memory 190 in addition to the components shown in FIG. 1.

The operation/display unit 170 is a touch panel type liquid crystal display device, for example. The operation/display unit 170 serves as an operation unit for inputting information regarding money handling. The operation/display unit 170 serves as a display unit that displays information regarding money handling.

The communication unit 180 communicates with an external device. For example, the money depositing/dispensing apparatus 100 can transmit, to the external device, information about the denominations of money and the quantity of money for each denomination stored in each of the storage units 150, the cassette 300, and the collection unit 400.

The memory 190 is a nonvolatile memory device. Various kinds of information required for operation of the money depositing/dispensing apparatus 100 are stored in the memory 190. The information stored in the memory 190 includes: information about the denominations of money and the quantity of money for each denomination stored in each of the storage units 150, the cassette 300, and the collection unit 400; information for determining whether or not a replenishment process of replenishing a storage unit 150 with money is required; collection setting; and replenishment setting.

The control unit 160 controls the function and operation of each component of the money depositing/dispensing apparatus 100. The control unit 160 receives information through the operation/display unit 170. The control unit 160 displays information on the operation/display unit 170. The control unit 160 controls each component, while referring to the various kinds of information stored in the memory 190, based on the operation performed on the operation/display unit 170 and/or the information received by the communication unit 180. Thus, the function and operation of the money depositing/dispensing apparatus 100 according to the embodiment are realized. According to an exemplary embodiment, the control unit is processing circuitry based on one or more general purpose processing circuitry such as microprocessors, microcontrollers, and digital signal processors, or dedicated processing circuits such as application specific integrated circuits, etc.

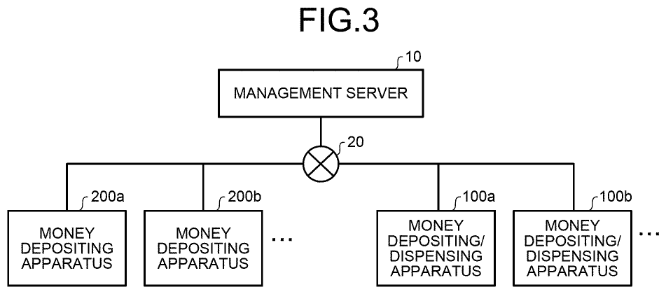

Next, the money handling system according to the present embodiment is described. FIG. 3 shows an exemplary configuration of the money handling system according to the present embodiment. The money handling system includes one or more money depositing/dispensing apparatuses 100, one or more money depositing apparatuses 200, and a management server 10. The money depositing/dispensing apparatus 100 and the money depositing apparatus 200 are installed in a store. The installation place of the management server 10 is not particularly limited. The management server 10 may be installed in the store or in another place outside the store.

The management server 10 is communicably connected to each money depositing/dispensing apparatus 100 and each money depositing apparatus 200 via a network 20. The management server 10 manages information of each money depositing/dispensing apparatus 100 and information of each money depositing apparatus 200. The information managed by the management server 10 includes the denominations of money and the quantity of money for each denomination being stored in each apparatus.

The money depositing apparatus 200 may be a money handling apparatus used by a customer visiting the store, or a money handling apparatus used by a clerk in a back office of the store to prepare change for transactions in the store. Hereinafter, the description is continued as an example in which the money depositing apparatus 200 is the money handling apparatus used by the customer. For example, the customer can bring a large amount of coins, he/she has saved at home, to the store and deposit these coins in the money depositing apparatus 200. Then, the customer can use the amount of the deposited coins for payment of a commodity he/she purchases in the store. Alternatively, the customer can change the amount of the deposited coins to banknotes and receive the banknotes at a customer service counter of the store.

The money depositing apparatus 200 executes a depositing process. In the depositing process, the money depositing apparatus 200 receives money in a depositing unit, recognizes and counts the received money by a recognition unit, and stores the money by denomination in a plurality of storage units. The denomination of money and the quantity of money stored in each storage unit are managed by the money depositing apparatus 200 and the management server 10.

The customer cannot execute the dispensing process with the money depositing apparatus 200, but the clerk of the store can execute the dispensing process with the money depositing apparatus 200. For example, the clerk executes the dispensing process to collect money from a storage unit in the money depositing apparatus 200 (collection process). The clerk receives money dispensed from a dispensing unit arranged for the collection process, into a box-like tray for collecting the money from the money depositing apparatus 200. The money in the tray can be deposited through the depositing unit 110 into the money depositing/dispensing apparatus 100 and used for replenishing the storage units 150 and the cassette 300.

The management server 10 collects and manages information regarding the money handling performed in the money depositing apparatus 200 and the money handling performed in the money depositing/dispensing apparatus 100. The information collected by the management server 10 includes: information about the denominations of money and the quantity of money for each denomination being stored in the storage units in the money depositing apparatus 200; and information about the denominations of money and the quantity of money for each denomination being stored in each of the storage units 150, the cassette 300, and the collection unit 400 in the money depositing/dispensing apparatus 100.

For example, the management server 10 monitors the storage quantity of money in each of the storage units 150, the cassette 300, and the collection unit 400 in the money depositing/dispensing apparatus 100, and determines to move money from the money depositing apparatus 200 to the money depositing/dispensing apparatus 100 when the monitored storage quantity becomes equal to or less than a predetermined threshold value. Meanwhile, for example, the management server 10 monitors the storage quantity of money in each of the storage units in the money depositing apparatus 200, and determines to move money from the money depositing apparatus 200 to the money depositing/dispensing apparatus 100 when the monitored storage quantity becomes equal to or greater than a predetermined threshold value.

When it is determined to perform movement of money from the money depositing apparatus 200 to the money depositing/dispensing apparatus 100, the money depositing/dispensing apparatus 100 executes the collection process to collect at least a part of money being stored in the cassette 300 into the collection unit 400, as described with reference to FIG. 1. After the available storage capacity of the cassette 300 is increased through execution of the collection process by the money depositing/dispensing apparatus 100, the management server 10 determines the denominations of money and the quantity of money for each denomination to be moved from the money depositing apparatus 200 to the money depositing/dispensing apparatus 100. That is, the management server 10 determines the denominations of money and the quantity of money for each denomination with which the money depositing/dispensing apparatus 100 is replenished.

The management server 10 transmits, to the money depositing apparatus 200 and the money depositing/dispensing apparatus 100, information about the money to be moved between these apparatuses. Based on the received information, the money depositing apparatus 200 feeds out money from the storage unit and dispenses the money. A clerk in charge of movement of money deposits the money that has been dispensed from the money depositing apparatus 200, through the depositing unit 110, into the money depositing/dispensing apparatus 100 to replenish the storage unit 150 and the cassette 300 with the deposited money.

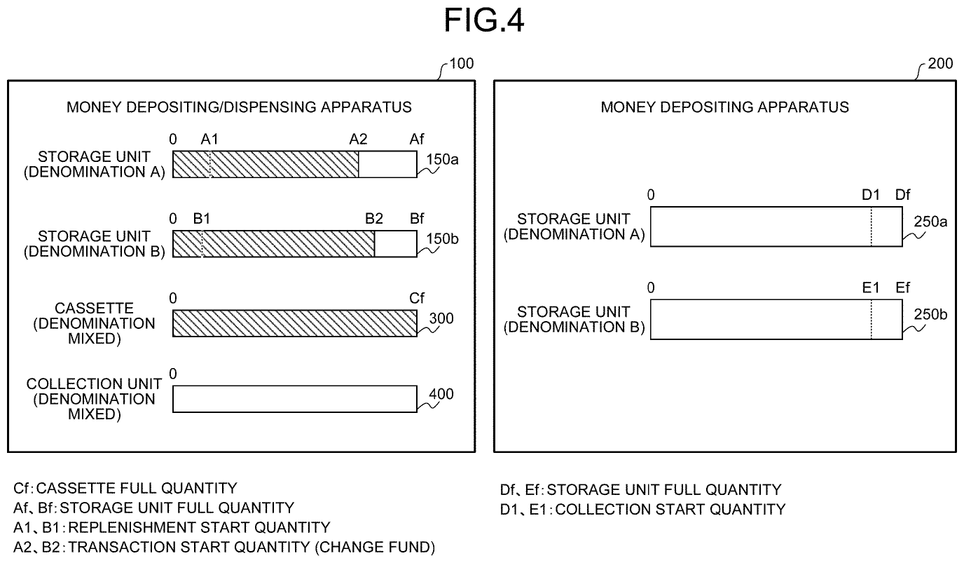

Next, a method of moving money from the money depositing apparatus 200 to the money depositing/dispensing apparatus 100 will be specifically described. In an example shown in FIG. 4, for ease of explanation, the money depositing/dispensing apparatus 100 includes two storage units 150 that are a storage unit 150a to store therein money of denomination A and a storage unit 150b to store therein money of denomination B, and the money depositing apparatus 200 includes two storage units 250 that are a storage unit 250a to store therein money of the denomination A and a storage unit 250b to store therein money of the denomination B.

FIG. 4 shows the storage states of money in the money depositing/dispensing apparatus 100 and the money depositing apparatus 200 at the time when the store is opened to start daily business. Before the store is opened, change funds for dispensing change to customers are prepared in the money depositing/dispensing apparatus 100 as shown in FIG. 4. The predetermined transaction start quantities A2, B2 of money are stored in the storage units 150a, 150b of the money depositing/dispensing apparatus 100, respectively. Specifically, money of the denomination A equivalent to the transaction start quantity A2 is stored in the storage unit 150a, and money of the denomination B equivalent to the transaction start quantity B2 is stored in the storage unit 150b.

When transaction with a customer is performed during the business hour of the store, money received from the customer is deposited and stored in the storage units 150, and change to be returned to the customer is dispensed from the storage units 150. The transaction start quantities A2, B2 are set to be less than the maximum storage quantities (full quantities) Af, Bf of the storage units 150a, 150b (A2<Af, B<Bf).

Replenishment start quantities A1, B1 are set for the storage units 150a, 150b of the money depositing/dispensing apparatus 100. The replenishment start quantities A1, B1 are threshold values for determining whether or not replenishment of money is required for the storage units 150a, 150b, respectively. When money in the storage unit 150a decreases after the store is opened and the quantity thereof becomes equal to or less than the quantity A1, it is determined that the replenishment process is required for the storage unit 150a. Likewise, it is determined that the replenishment process is required for the storage unit 150b when the storage quantity of money in the storage unit 150b becomes equal to or less than the quantity B1. Whether or not the replenishment process for the storage unit 150 is required is determined each time the dispensing process is executed in the money depositing/dispensing apparatus 100.

Before the store is opened, money of the maximum storage quantity (full quantity) Cf is stored in the cassette 300 as shown in FIG. 4. Money received from the customer at the time of transaction with the customer is not directly stored in the cassette 300. Therefore, money is stored up to the maximum storage quantity in the cassette 300. Money of the denomination A and money of the denomination B are stored in a mixed state in the cassette 300. When the storage units 150a, 150b need to be replenished with money after the store is opened, the storage units 150a and 150b can be replenished with the money fed out from the cassette 300.

Before the store is opened, the collection unit 400 is emptied as shown in FIG. 4. After the store is opened, when collecting money from the storage units 150 and the cassette 300, the collection unit 400 is used for storing the collected money. Money to be stored in the collection unit 400 is not limited to the money collected from the storage units 150 and the cassette 300. For example, the collection unit 400 is used to store money that cannot be stored in the storage units 150 because the storage units 150 are full and/or the money is significantly damaged and not suitable for dispensing. The collection unit 400 can store money therein but cannot feed out money therefrom. Therefore, the store is opened with the collection unit 400 being empty so that as much money as possible is collected into the collection unit 400.

Before the store is opened, the storage units 250a and 250b of the money depositing apparatus 200 are emptied as shown in FIG. 4. The customer can perform only the depositing process in the money depositing apparatus 200. Therefore, the storage units 250 are emptied so that as much money as possible can be deposited therein. After the store is opened, money of the denomination A can be stored up to the maximum storage quantity (full quantity) Df in the storage unit 250a. Likewise, money of the denomination B can be stored up to the maximum storage quantity (full quantity) Ef in the storage unit 250b.

Collection start quantities D1, E1 are set for the storage units 250a, 250b of the money depositing apparatus 200, as threshold values for determining whether or not collection of money is required, respectively. When money in the storage unit 250a increases and the quantity thereof becomes equal to or greater than the collection start quantity D1, it is determined that the collection process is required for the storage unit 250a. Likewise, when the storage quantity of money in the storage unit 250b becomes equal to or greater than collection start quantity E1, it is determined that the collection process is required for the storage unit 250b. Whether or not the collection process for the storage unit 250 is required is determined each time the depositing process is executed in the money depositing apparatus 200.

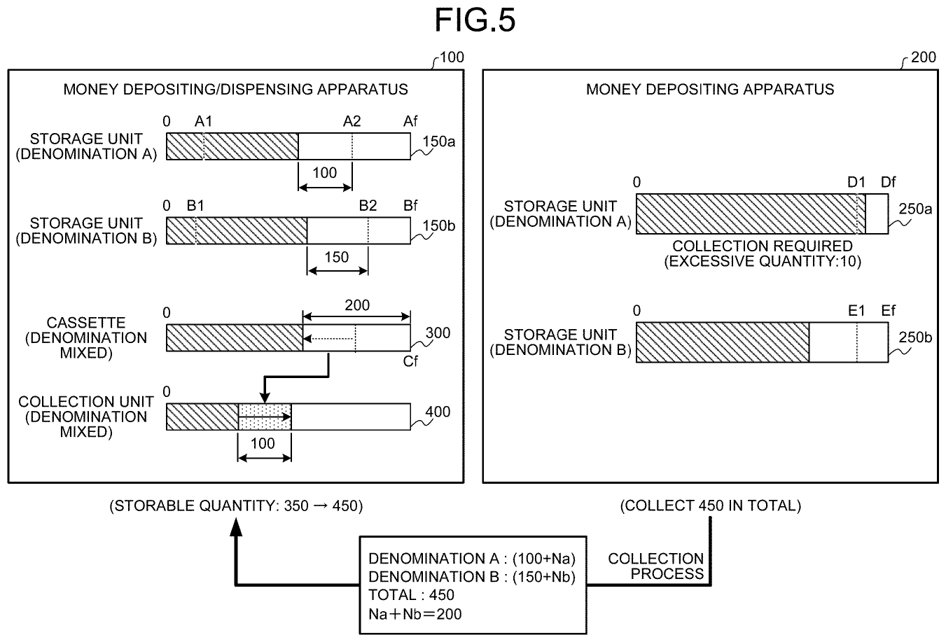

FIG. 5 illustrates an example of a method of moving money from the money depositing apparatus 200 which needs collection of money, to the money depositing/dispensing apparatus 100. As shown in FIG. 5, when the storage quantity of money becomes equal to or greater than the collection start quantity D1 in the storage unit 250a of the money depositing apparatus 200, the money depositing apparatus 200 determines that the collection process is required for the storage unit 250a, and notifies the management server 10 of the same. Then, the management server 10 determines to move money from the money depositing apparatus 200 to the money depositing/dispensing apparatus 100, and notifies the money depositing/dispensing apparatus 100 of the same.

Upon receiving the notification, the money depositing/dispensing apparatus 100 recognizes that the apparatus 100 will be replenished with money moved from the money depositing apparatus 200 through the depositing unit 110. Then, the money depositing/dispensing apparatus 100 executes the collection process of collecting at least a part of money being stored in the cassette 300, into the collection unit 400, based on the collection setting. FIG. 5 indicates that 100 pieces of money are collected from the cassette 300 into the collection unit 400 and the quantity of money storable in the cassette 300 is increased from 100 to 200, as the result of the collection process.

In order to make the quantity of money in the storage unit 250a of the money depositing apparatus 200 less than the collection start quantity D1, 10 pieces of money need to be collected as shown in FIG. 5. In this situation, the management server 10 does not determine to collect 10 pieces of money of the denomination A but determines the denominations of money and the quantity of money for each denomination to be collected from the money depositing apparatus 200, based on the denominations of money and the quantity of money for each denomination storable in both the storage units 150 and the cassette 300 of the money depositing/dispensing apparatus 100.

In the money depositing/dispensing apparatus 100, the depositing process is executed for transaction with the customer. The money depositing/dispensing apparatus 100 needs to store deposited money in the storage units 150. Therefore, in order to secure a storage space for the deposited money, when performing the replenishment process, the storage unit 150a is replenished with money until reaching the transaction start quantity A2 and the storage unit 150b is replenished with money until reaching the transaction start quantity B2. Accordingly, the management server 10 recognizes that the quantity of money of the denomination A storable in the storage unit 150a is 100 and the quantity of money of the denomination B storable in the storage unit 150b is 150, as shown in FIG. 5.

At the time of transaction with the customer, money is not directly stored in the cassette 300. Therefore, in the replenishment process, the cassette 300 is replenished with money until reaching the maximum storage quantity Cf. Accordingly, the management server 10 recognizes that the quantity of money storable in the cassette 300 is 200 as shown in FIG. 5. In addition, the management server 10 recognizes that denominations storable in the cassette 300 are denomination A and denomination B.

As shown in FIG. 5, the management server 10 determines to collect 100 pieces of money of the denomination A, 150 pieces of money of the denomination B, and 200 pieces of money of a mixture of the denomination A and the denomination B, i.e., 450 pieces of money in total, from the money depositing apparatus 200 in order to replenish the money depositing/dispensing apparatus 100 with the collected money.

As described above, the money depositing/dispensing apparatus 100 executes the collection process inside the apparatus 100 to move money from the cassette 300 to the collection unit 400, before the movement of money from the money depositing apparatus 200 to the money depositing/dispensing apparatus 100. As a result, 100 pieces of money are collected from the cassette 300 to the collection unit 400 in the collection process, and the quantity of money to be collected from the money depositing apparatus 200, i.e., the quantity of money storable in the money depositing/dispensing apparatus 100, is increased from 350 to 450.

Subsequently, the management server 10 determines the denominations of money and the quantity of money for each denomination to be collected from the money depositing apparatus 200, i.e., with which the money depositing/dispensing apparatus 100 is to be replenished. The management server 10 determines the denominations of money and the quantity of money for each denomination such that the quantity of money of the denomination A is 100 or more, the quantity of money of the denomination B is 150 or more, and the total quantity of money of the denomination A and money of the denomination B is 450. This determination is performed based on replenishment setting prepared in advance.

As shown in FIG. 5, (100+Na) pieces of money of the denomination A and (150+Nb) pieces of money of the denomination B, i.e., 450 pieces of money in total. (Na+Nb=200), are respectively collected from the storage unit 250a and the storage unit 250b of the money depositing apparatus 200.

For example, the management server 10 determines the quantities of money Na and Nb so as to be equal to each other, based on the replenishment setting. In this case, the management server 10 determines that Na=100 and Nb=100. As a result, 200 pieces of money of the denomination A and 250 pieces of money of the denomination B are collected from the money depositing apparatus 200, and the money depositing/dispensing apparatus 100 is replenished with the collected money.

For another example, the management server 10 determines the quantities of money Na and Nb, based on the replenishment setting to determine the quantities according to transition of the storage quantity of money for each denomination in the money handling system. For example, the management server 10 can determine the quantities of money Na and Nb, based on transition of the storage quantity of money in the storage units 250 of the money depositing apparatus 200 within a predetermined time period immediately before determining the collection of money from the money depositing apparatus 200. For example, the management server 10 determines the quantities of money Na and Nb, based on the ratio of the quantities of money of the respective denominations deposited in the money depositing apparatus 200 within 1 hour immediately before the determination of collection. When the ratio of quantities between money of the denomination A and money of the denomination B, which have been deposited in the money depositing apparatus 200 within 1 hour immediately before the determination of collection, is 3:1, the management server 10 determines a breakdown of the total quantity of 200 to be Na=−0.150 and Nb=50.

Meanwhile, the management server 10 can determine the quantities of money Na and Nb, based on transition of the storage quantity of money in the storage units 150 of the money depositing/dispensing apparatus 100 within a predetermined time period immediately before the determination of collection from the money depositing apparatus 200. For example, the management server 10 determines the quantities of money Na and Nb, based on the ratio of the quantities of money of the respective denominations deposited in and dispensed from the money depositing/dispensing apparatus 100 within 1 hour immediately before the determination of collection. For example, when the ratio of quantities between money of the denomination A and money of the denomination B, which have been decreased through the depositing process and the dispensing process executed in the money depositing/dispensing apparatus 100 within 1 hour immediately before the determination of collection, is 3:1, the management server 10 determines a breakdown of the total quantity of 200 to be Na=150 and Nb=50.

The management server 10 determines the quantity (100+Na) of money of the denomination A and the quantity (100+Nb) of money of the denomination B to be collected from the money depositing apparatus 200 based on the replenishment setting, and transmits information indicating the determination result to the money depositing/dispensing apparatus 100 and the money depositing apparatus 200.

When the clerk has performed a predetermined operation on the operation/display unit of the money depositing apparatus 200 to execute the collection process from the money depositing apparatus 200 to the money depositing/dispensing apparatus 100, the money depositing apparatus 200 dispenses the money to be collected, based on the information received from the management server 10. As a result, in the money depositing apparatus 200, the storage quantities of money in the storage units 250a, 250b become less than the collection start quantities D1, E1 and thus the available storage capacities increase.

The clerk carries 450 pieces of money in total dispensed from the money depositing apparatus 200, to the installation place of the money depositing/dispensing apparatus 100. When the clerk has performed a predetermined operation on the operation/display unit 170, the control unit 160 starts the replenishment process based on the information received from the management server 10. In the replenishment process, money deposited from the depositing unit 110 is recognized by the recognition unit 120, 100 pieces of money of the denomination A are stored in the storage unit 150a, 150 pieces of money of the denomination B are stored in the storage unit 150b and the residual 200 (Na+Nb=200) pieces of money are stored in the cassette 300. As a result, the money depositing/dispensing apparatus 100 stores money equivalent to the transaction start quantities A2, B2 in the storage units 150a, 150b, respectively, and stores money equivalent to the maximum storage quantity Cf in the cassette 300. That is, the storage state of money in the money depositing/dispensing apparatus 100 returns to the same state as before the opening of the store shown in FIG. 4.

When the storage quantity of money in the storage units 150a becomes less than the replenishment start quantity A1 and/or the storage quantity of money in the storage unit 150b becomes less than the replenishment start quantity B1 as the result of the dispensing process executed in the money depositing/dispensing apparatus 100 while the store is open, the control unit 160 determines that the replenishment process is required for the storage unit 150a and/or 150b.

The quantity of money for replenishing each of the storage units 150a, 150b when the replenishment process is required, can be set in advance as a replenishment quantity. For example, when the replenishment quantity of the storage unit 150b is set to 100, the control unit 160 determines whether or not 100 pieces of money of the denomination B can be supplied from the cassette 300 to the storage unit 150b.

When the replenishment process is executable by using money being stored in the cassette 300, the control unit 160 feeds out money from the cassette 300, recognizes the fed out money by the recognition unit 120, and stores 100 pieces of money of the denomination B in the storage unit 150b. When the money fed out from the cassette 300 is money of the denomination A, this money is returned to the cassette 300. However, it can be set that the money of the denomination A which is not used for the replenishment is stored in the storage unit 150a, instead of being returned to the cassette 300, until the storage quantity of money in the storage unit 150a reaches the transaction start quantity A2. In this setting, the money of the denomination A is returned to the cassette 300 after the storage quantity of money in the storage unit 150a reaches the transaction start quantity A2.

When the replenishment process is required but cannot be executed by using money in the cassette 300, the control unit 160 notifies the management server 10 of the same. The management server 10 determines to collect money from the money depositing apparatus 200 and replenish the money depositing/dispensing apparatus 100 with the collected money.

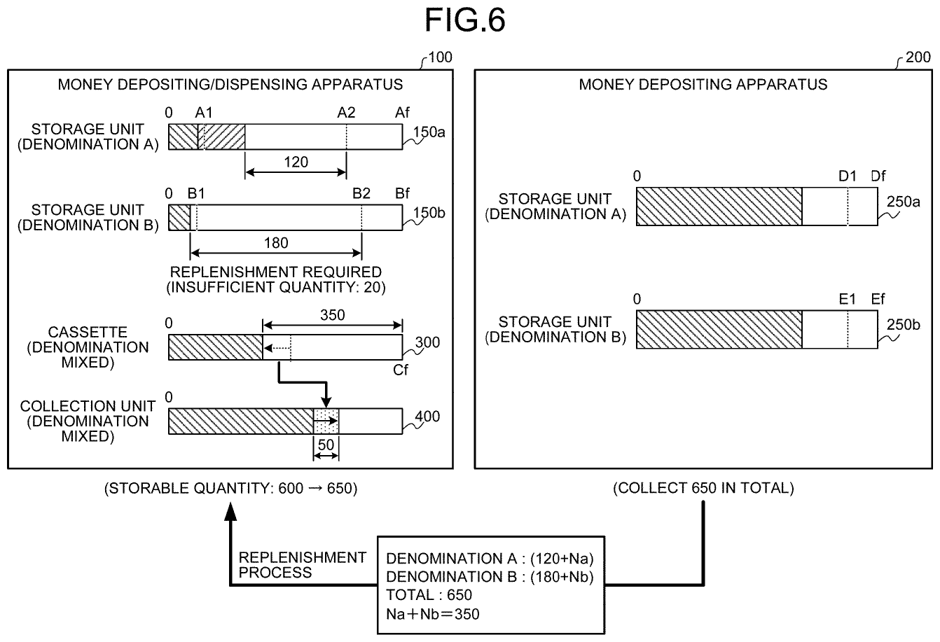

FIG. 6 illustrates an example of a method of moving money from the money depositing apparatus 200 to the money depositing/dispensing apparatus 100 which needs to be replenished with money. As shown in FIG. 6, in a case where the replenishment process needs to be executed because the storage quantity of money in the storage unit 150b becomes less than the replenishment start quantity B1, but cannot be executed by using money stored in the cassette 300, the control unit 160 executes the collection process inside the money depositing/dispensing apparatus 100 as described with reference to FIG. 1. FIG. 6 indicates that, as the result of the collection process for collecting at least a part of money being stored in the cassette 300 into the collection unit 400 based on the collection setting, 50 pieces of money are collected from the cassette 300 into the collection unit 400, and the quantity of money storable in the cassette 300 is increased from 300 to 350.

Based on the storage status shown in FIG. 6, the management server 10 determines to collect 120 pieces of money of the denomination A, 180 pieces of money of the denomination B, and 350 pieces of money of a mixture of the denomination A and the denomination B, i.e., 650 pieces of money in total, from the money depositing apparatus 200, in order to replenish the money depositing/dispensing apparatus 100 with the collected money.

As described with reference to FIG. 5, based on the replenishment setting, the management server 10 determines a breakdown of money to be collected from the storage units 250a, 250b of the money depositing apparatus 200 such that the total of (120+Na) pieces of money of the denomination A and (180+Nb) pieces of money of the denomination B becomes 650, i.e., such that Na+Nb=350. The management server 10 transmits information about the money to be collected from the money depositing apparatus 200, to the money depositing/dispensing apparatus 100 and the money depositing apparatus 200.

The clerk executes the collection process in the money depositing apparatus 200 to collect, from the money depositing apparatus 200, money of the denominations and the quantity for each denomination determined by the management server 10. As a result, in the money depositing apparatus 200, available storage capacities of the storage units 250a, 250b increase.

The clerk executes the replenishment process in the money depositing/dispensing apparatus 100 to replenish the money depositing/dispensing apparatus 100 with the money collected from the money depositing apparatus 200 through the depositing unit 110. The money depositing/dispensing apparatus 100 recognizes, by the recognition unit 120, the money received in the depositing unit 110, and stores the recognized money in the corresponding storage unit 150. When the storage quantity of money in the storage unit 150a increases and reaches A2, the subsequent money of the denomination A is stored in the cassette 300. Likewise, when the storage quantity of money in the storage unit 150b increases and reaches B2, the subsequent money of the denomination B is stored in the cassette 300. As a result, in the money depositing/dispensing apparatus 100, money equivalent to the transaction start quantities A2, B2 are stored in the storage units 150a, 150b, and money equivalent to the maximum storage quantity Cf is stored in the cassette 300.

When it has been determined to move money from the money depositing apparatus 200 to the money depositing/dispensing apparatus 100, the collection process of collecting money from the cassette 300 into the collection unit 400 is executed inside the money depositing/dispensing apparatus 100 as described with reference to FIG. 1. The collection process of collecting money from the cassette 300 into the collection unit 400 can also be executed when executing the replenishment process of replenishing the storage unit 150 with money fed out from the cassette 300 in the money depositing/dispensing apparatus 100.

The collection process to be executed when the storage unit 150 is replenished with money fed from the cassette 300 will be described with an example in which the money depositing/dispensing apparatus 100 has six storage units 150 and money of denominations A to F are stored for each denomination in the respective storage units 150. For ease of description, hereinafter, the six storage units 150 respectively storing money of the denominations A to F are referred to as storage units Sa to Sf.

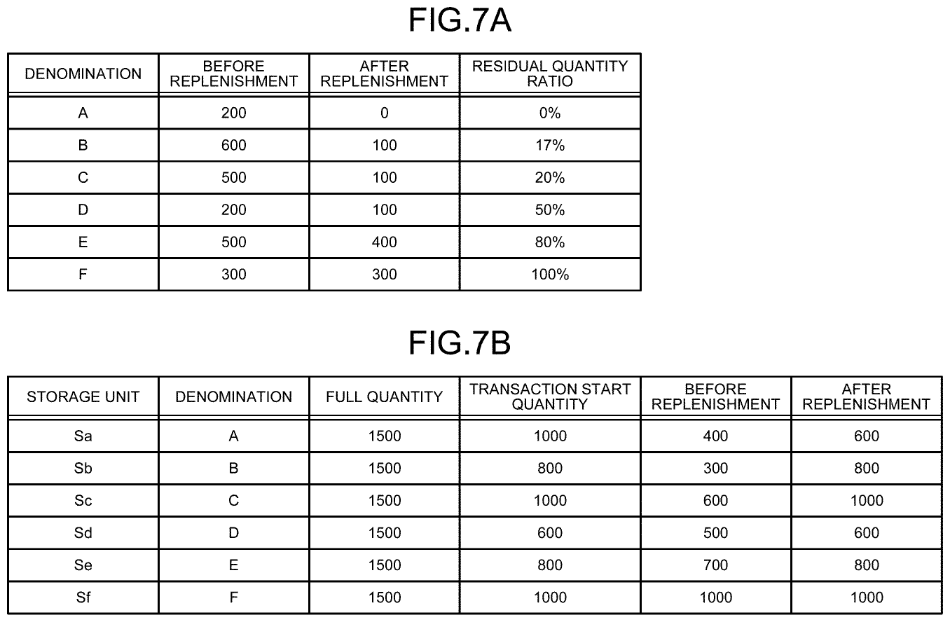

FIGS. 7A and 7B illustrate examples of change in the quantity of money before and after a replenishment process of replenishing the storage units Sa to Sf with money fed out from the cassette 300. Specifically, FIG. 7A shows change in the number of pieces of money (quantity of money) in the cassette 300, and FIG. 7B shows change in the number of pieces of money (quantity of money) in each of the storage units Sa to Sf.

When the replenishment process of replenishing the storage units Sa to Sf with money fed out from the cassette 300 has been executed, the quantity of money in the cassette 300 decreases. FIG. 7A shows that the quantity of money of each of the denominations A to F stored in the cassette 300 has decreased from the quantity shown in an item of “before replenishment” to the quantity shown in an item of “after replenishment”. An item of “residual quantity ratio” indicates a ratio of the quantity of money after replenishment to the quantity of money before replenishment. For example, as for money of the denomination C, the quantity thereof in the cassette 300 was 500 before the replenishment process, and decreased to 100 after the replenishment process, which corresponds to 20% of the quantity before the replenishment process.

After the replenishment process, the quantity of money increases in at least one of the storage units Sa to Sf. FIG. 7B shows that the storage quantity of money in each of the storage units Sa to Sf has increased from the quantity shown in the item of “before replenishment” to the quantity shown in the item of “after replenishment”. In FIG. 7B, an item of “full quantity” indicates the maximum storage quantity of money in each of the storage units Sa to Sf. An item of “transaction start quantity” indicates the quantity of money stored as change fund in each of the storage units Sa to Sf before the store is opened to start daily business. The item of “transaction start quantity” also indicates that money can be stored until reaching this quantity when executing the replenishment process. For example, as for the storage unit Sa, 1000 pieces of change fund are storable while the maximum storage quantity is 1500, and the quantity of money that was 400 before the replenishment process has increased to 600 after the replenishment process. The increment of 200 in the quantity of money in the storage unit Sa corresponds to the decrement of 200 in the quantity of money of the denomination A shown in FIG. 7A.

After completing the replenishment process from the cassette 300 to the storage units 150 inside the money depositing/dispensing apparatus 100, the control unit 160 determines the denomination of money to be moved from the cassette 300 into the collection unit 400, based on the change in the quantity of money in the cassette 300 before and after the replenishment process shown in FIG. 7A, i.e., based on the residual quantity ratio.

The control unit 160 specifies a denomination having a high residual quantity ratio, based on the information shown in FIG. 7A. The denomination having the high residual quantity ratio indicates that a quantity of money of this denomination supplied to the storage units Sa to Sf during the replenishment process is little. That is, the denomination having the high residual quantity ratio is a denomination of money of which a quantity decreases at a slow pace in the money depositing/dispensing apparatus 100. The control unit 160 compares the residual quantity ratio of each denomination with a predetermined threshold value to determine the denomination of money to be collected from the cassette 300.

For example, when the threshold value for the residual quantity ratio is set to 55%, the control unit 160 selects the denomination E and the denomination F, each having the residual quantity ratio higher than 55%, as denominations of money to be collected from the cassette 300 into the collection unit 400, based on the information shown in FIGS. 7A and 7B. That is, money of the denomination E and the denomination F, which decreases at a slow pace in the money depositing/dispensing apparatus 100, need not be held in the cassette 300 and therefore is determined to be collected from the cassette 300 into the collection unit 400. The control unit 160 displays information about the determined denominations to be collected from the cassette 300, on the screen of the operation/display unit 170, thereby notifying the clerk of the information.

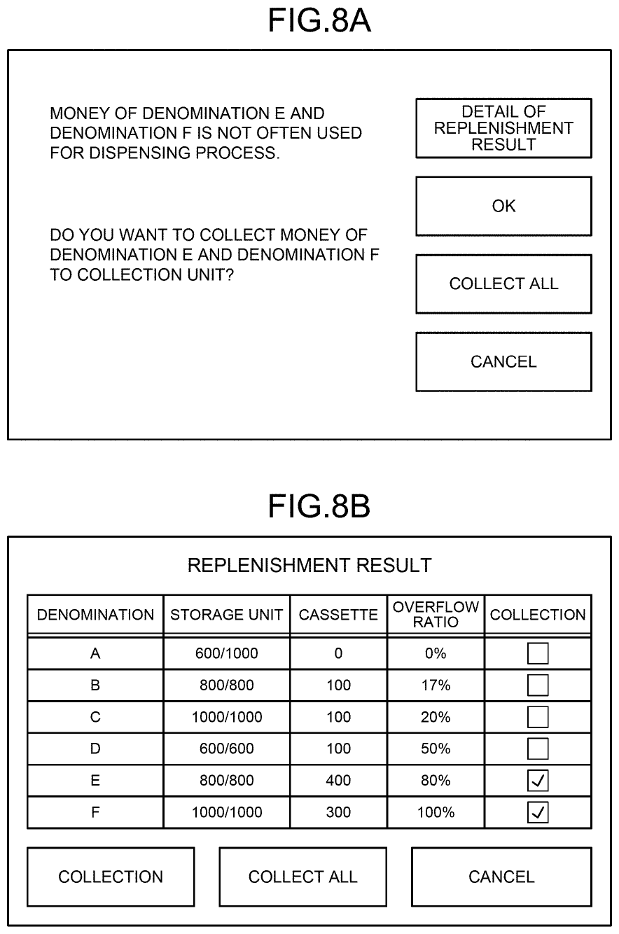

FIGS. 8A and 8B each show an example of a notification screen displayed on the operation/display unit 170. On the screen, information indicating the denominations having been determined to be collected from the cassette 300 and information that asks the clerk to determine whether or not to collect money of these denominations into the collection unit 400, are displayed. In addition, on the screen, a button displaying “details of replenishment result”, an OK button, a Collect All button, and a Cancel button are displayed. When the clerk operates the Cancel button shown in FIG. 3A, the collection process of money from the cassette 300 into the collection unit 400 is not executed.

When the clerk operates the OK button on the operation/display unit 170 shown in FIG. 8A, the control unit 160 starts the collection process of collecting money of the denomination E and money of the denomination F from the cassette 300 into the collection unit 400.

In the collection process, the control unit. 160 feeds out money from the cassette 300, causes the recognition unit 120 to recognize the fed out money, and stores money of the denomination E and money of the denomination F into the collection unit 400 while returning money of other denominations into the cassette 300. However, it can be set that money of the denominations A to D that are not to be collected may be stored in the corresponding storage units Sa to Sd, instead of being returned to the cassette 300, until the storage quantities of money in the storage units Sa to Sd reach the predetermined transaction start quantities. In this setting, the money of the denominations A to D is returned to the cassette 300 after the storage quantity of money in the corresponding storage unit reaches the transaction start quantities.

As shown in FIG. 7A, 400 pieces of money of the denomination E and 300 pieces of money of the denomination F are being stored in the cassette 300. The control unit 160 moves these 400 pieces of money of the denomination E and 300 pieces of money of the denomination F from the cassette 300 into the collection unit 400 to end the collection process. As a result of the collection process, the available storage capacity of the cassette 300 is increased by 700.

The clerk can operates the Collect All button on the screen shown in FIG. 8A to collect all money from the cassette 300. When the clerk operates the Collect All button, the control unit 160 starts the collection process of collecting all the money in the cassette 300, into the collection unit 400. The control unit 160 moves all the money from the cassette 300 into the collection unit 400 to end the collection process. As a result of the collection process, the cassette 300 is emptied.

When the clerk operates the button displaying “details of replenishment result” on the screen shown in FIG. 8A, the screen shown in FIG. 8B is displayed. The clerk can check the information shown in FIGS. 7A and 7B on this screen.

In FIG. 8B, an item of “storage unit” indicates a ratio of the current storage quantity of money to the transaction start quantity set for each of the storage units Sa to Sf. An item of “cassette” indicates the quantity of money currently stored in the cassette 300. For example, as for money of the denomination A, 600 pieces of money are currently stored in the storage unit Sa while the transaction start quantity is 1000, and the quantity of money remaining in the cassette 300 is 0. An item of “overflow ratio” corresponds to the “residual quantity ratio” shown in FIG. 7A. For example, as for money of the denomination F, the overflow ratio thereof indicates that this money has not been used for the replenishment process and is 100% left in the cassette 300 even after the replenishment process. An item of “collect” indicates each denomination having been determined to be collected from the cassette 300, by the control unit 160. FIG. 8B indicates that the denomination E and the denomination F having checkmarks in the corresponding check boxes are to be collected.

The clerk can operates the Collect button on the screen shown in FIG. 8B to collect money of the denomination E and money of the denomination F from the cassette 300 into the collection unit 400. Alternatively, the clerk can select one or more denomination to be collected by checking a corresponding checkbox displayed at the item of “collect” on the screen and then operate the Collect button to collect money of the selected denomination from the cassette 300 into the collection unit 400. Still alternatively, the clerk can operates the Collect All button to collect all the money stored in the cassette 300 into the collection unit 400. When the clerk operates a Cancel button on the screen shown in FIG. 8B, the display returns to the screen shown in FIG. 8A.

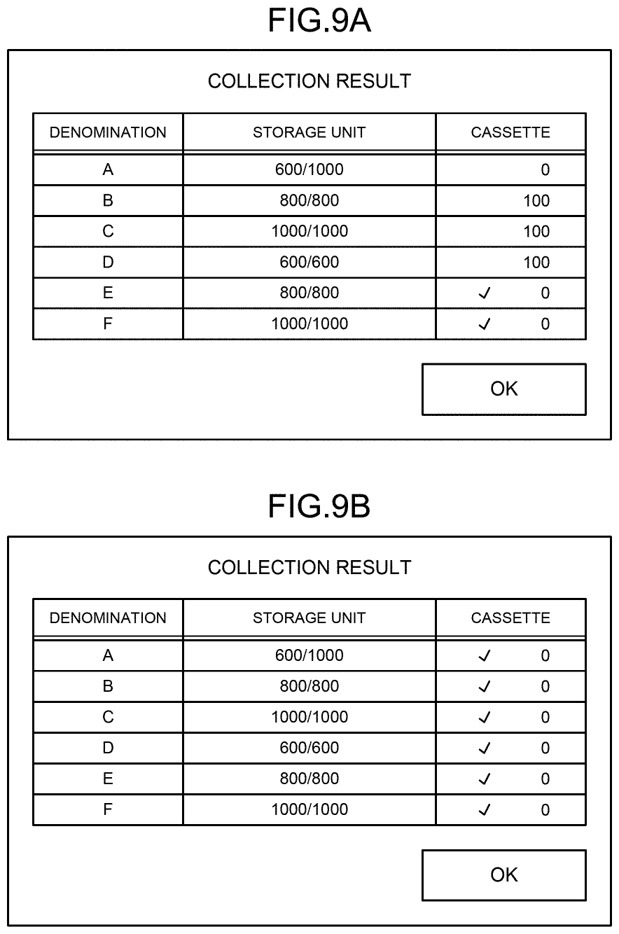

After the collection process of collecting the money from the cassette 300 into the collection unit 400 has been executed, a screen showing the collection result is displayed on the operation/display unit 170. FIGS. 9A and 9B each show an example of the screen of the collection result displayed on the operation/display unit 170. When the collection process of collecting money of the denomination E and money of the denomination F has been executed by operating the OK button on the screen shown in FIG. 8A or the Collect button on the screen shown in FIG. 8B, the screen shown in FIG. 9A is displayed. The screen of FIG. 9A shows that money of the denomination E and money of the denomination F, which have checkmarks, have been collected from the cassette 300 into the collection unit 400, and the quantities of these denominations E and F have become 0 (zero).

When the clerk has executed the collection process of collecting all the money from the cassette 300 by operating the Collect All button on the screen shown in FIG. 8A or the screen shown in FIG. 8B, the screen shown in FIG. 9B is displayed. The screen of FIG. 9B shows that money of all denominations having checkmarks have been collected from the cassette 300 into the collection unit 400, and the cassette 300 is emptied.

When the clerk presses the OK button on the screen shown in FIG. 9A or the screen shown in FIG. 9B, the control unit 160 displays a screen that asks the clerk whether or not to start a process for collecting money from the money depositing apparatus 200 and replenishing the money depositing/dispensing apparatus 100 with the money collected from the money depositing apparatus 200.

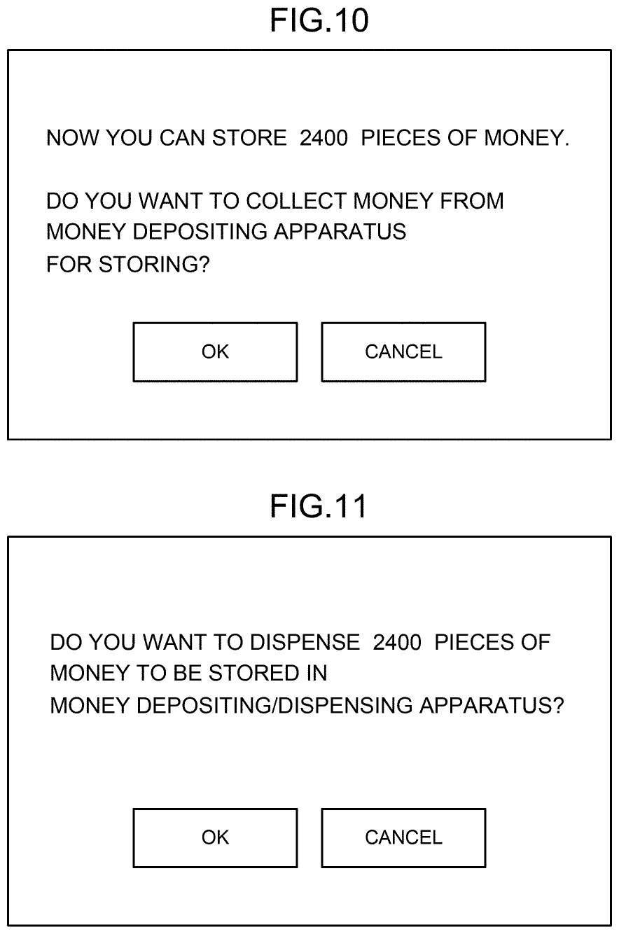

FIG. 10 shows an example of a screen displayed on the operation/display unit 170 after completion of the collection process for increasing the available storage capacity of the cassette 300. After the collection process from the cassette 300 has been completed, the control unit 160 calculates a total quantity of the quantity of money storable in the cassette 300 and the quantities of money storable in the storage units Sa to Sf, as described with reference to FIG. 5 and FIG. 6. For example, if 2400 pieces of money in total are storable in the cassette 300 and the storage units Sa to Sf, the screen shown in FIG. 10 is displayed. When the clerk operates a Cancel button on this screen, the screen disappears and the money depositing/dispensing apparatus 100 returns to the state where the depositing process and the dispensing process can be executed.

When the clerk operates an OK button on the screen shown in FIG. 10, the control unit 160 of the money depositing/dispensing apparatus 100 transmits, to the management server 10, information to request execution of a process of collecting money from the money depositing apparatus 200 and replenishing the money depositing/dispensing apparatus 100 with the money collected from the money depositing apparatus 200. Upon receiving this information, the management server 10 determines the denominations of money and the quantity of money for each denomination to be moved from the money depositing apparatus 200 to the money depositing/dispensing apparatus 100, as described with reference to FIG. 5 and FIG. 6. The management server 10 transmits the determination result to the money depositing/dispensing apparatus 100 and the money depositing apparatus 200 to execute the movement of money.

When the clerk, who has operated the OK button on the screen of the operation/display unit 170 of the money depositing/dispensing apparatus 100 shown in FIG. 10, moves to the installation place of the money depositing apparatus 200, and performs a predetermined operation with the operation/display unit of the money depositing apparatus 200, a screen that asks whether or not to start collection of money is displayed on the operation/display unit of the money depositing apparatus 200. FIG. 11 shows an example of a screen displayed on the operation/display unit of the money depositing apparatus 200. When the clerk operates an OK button on this screen, the money depositing apparatus 200 dispenses, from the dispensing unit for collection, money of the denominations and quantity for each denomination, determined by the management server 10, based on the information received from the management server 10. The clerk, carrying the dispensed money, returns to the installation place of the money depositing/dispensing apparatus 100, and operates the operation/display unit 170 to deposit the money from the depositing unit 110. Thus, as described with reference to FIG. 5 and FIG. 6, the storage units Sa to Sf and the cassette 300 can be replenished with the money collected from the money depositing apparatus 200.

Since money is moved from the money depositing apparatus 200 to the money depositing/dispensing apparatus 100 after the available storage capacity of the cassette 300 is increased inside the money depositing/dispensing apparatus 100, the money depositing/dispensing apparatus 100 can be replenished with a larger quantity of money. Increasing the quantity of money to be supplied in the replenishment process at one time results in a reduction in the frequency of the replenishment process to be executed while the store is open, thereby reducing the burden on the clerk.

In the example shown in FIG. 5 and FIG. 6 of the present embodiment, the denominations of money and the quantity of money for each denomination to be collected from the money depositing apparatus 200 are determined based on the denominations of money and the quantity of money for each denomination storable in both the storage unit 150 and the cassette 300 of the money depositing/dispensing apparatus 100. However, information of the collection unit 400 may be used for determining the denominations of money and the quantity of money for each denomination to be collected from the money depositing apparatus 200. For example, the denominations of money and the quantity of money for each denomination to be collected from the money depositing apparatus 200 may be determined such that a part of the money collected from the money depositing apparatus 200 is stored in the collection unit 400 based on the storing state of money in the collection unit 400.

In the example shown in FIG. 5 and FIG. 6 of the present embodiment, the denominations of money and the quantity of money for each denomination to be collected from the money depositing apparatus 200 are determined such that the cassette 300 of the money depositing/dispensing apparatus 100 becomes full and money of the transaction start quantity is stored in the storage unit 150. However, the determination method is not limited thereto. For example, the denominations of money and the quantity of money for each denomination to be collected from the money depositing apparatus 200 may be determined such that the quantity of money in the cassette 300 becomes less than the maximum storage quantity after movement of money from the money depositing apparatus 200 to the money depositing/dispensing apparatus 100. For another example, the denominations of money and the quantity of money for each denomination to be collected from the money depositing apparatus 200 may be determined such that the quantity of money in the storage unit 150 becomes a predetermined quantity different from the transaction start quantity after movement of money from the money depositing apparatus 200 to the money depositing/dispensing apparatus 100.

In the example shown in FIG. 7A to FIG. 9B of the present embodiment, after one replenishment process has been executed in the money depositing/dispensing apparatus 100, the denomination of money to be collected from the cassette 300 into the collection unit 400 is determined based on a change in the quantity of money in the cassette 300 before and after the replenishment process. However, the method of determining money to be collected is not limited thereto. For example, as for a plurality of times of the replenishment process, the replenishment quantity of money for each denomination may be accumulated, and the denomination of money to be collected from the cassette 300 into the collection unit 400 may be determined based on the accumulated quantity of money for each denomination. In the present embodiment, the threshold value for determining denomination is uniformly set to 55% regardless of denomination. However, threshold values different from each other by denomination may be set.

In the present embodiment, money of a denomination having a small decrement is collected from the cassette 300 into the collection unit 400, based on the decrement of money for each denomination in the money depositing/dispensing apparatus 100. However, a denomination of money to be collected may be selected based on an increment. For example, by expressing the increment as a negative decrement, each process can be executed as described above.

In the present embodiment, the money handling system includes the management server 10, the money depositing/dispensing apparatus 100, and the money depositing apparatus 200. However, these are conceptual functional components, and thus the components of the money handling system are not physically limited thereto. For example, the money depositing/dispensing apparatus 100 may implement a part of or the entire function and operation of the management server 10, or the management server 10 may implement a part of or the entire function and operation of the money depositing/dispensing apparatus 100. Distributed or integrated forms of each apparatus are not limited to the above-described examples, and all or some of the forms may be distributed or integrated functionally or physically in any unit, depending on various loads, use statuses, or the like.

In the present embodiment, money is moved from the money depositing apparatus 200 to the money depositing/dispensing apparatus 100. However, a money handling apparatus from which money is moved may be a money depositing/dispensing apparatus or a money dispensing apparatus. Meanwhile, the money handling apparatus to be replenished with collected money is the money depositing/dispensing apparatus 100 in the above example, but may be a money dispensing apparatus that executes only a dispensing process without executing a depositing process.

In the present embodiment, the cassette 300 is used as a mixture storage unit in which a plurality of denominations of money are stored in a mixed state. However, one of the storage units 150 may be used as a mixture storage unit. The storage unit 150, instead of the cassette 300, performs storage of money received in the depositing unit 110, and feeding-out of money for replenishing another storage unit 150 and money to be collected into the collection unit 400, whereby each process described above can be achieved.

In the present embodiment, a money depositing/dispensing apparatus is configured to include: a denomination-based storage unit configured to store therein money for each denomination; a mixture storage unit configured to store therein money in a denomination mixed state; a collection storage unit configured to store therein money such that the money cannot be fed out therefrom; a transport unit configured to move money between the storage units; and a control unit configured to perform control such that predetermined money is moved from the mixture storage unit to the collection storage unit when the denomination-based storage unit needs to be replenished with money, and to determine denominations and quantities of money with which the denomination-based storage unit and the mixture storage unit are replenished, based on a storage quantity of money in the mixture storage unit after the movement and on a storage quantity of money in the denomination-based storage unit.

In the above configuration, the predetermined money is money of a predetermined denomination.

In the above configuration, the predetermined money is determined based on a decrement of money, for each denomination, that has decreased in the denomination-based storage unit within a predetermined time period.

In the above configuration, the predetermined money is determined based on a quantity of money, for each denomination, that has been moved from the mixture storage unit to the denomination-based storage unit within a predetermined time period.

In the above disclosure, the predetermined money is money of a predetermined quantity.

In the above disclosure, the predetermined money is money of a quantity that is obtained by multiplying a quantity of money stored in the mixture storage unit by a predetermined ratio.

In the present embodiment, a money handing system is configured to include a money depositing/dispensing apparatus, and a money dispensing apparatus capable of dispensing money to be moved to the money depositing/dispensing apparatus. The money depositing/dispensing apparatus includes: a denomination-based storage unit configured to store therein money for each denomination; a mixture storage unit configured to store therein money in a denomination mixed state; a collection storage unit configured to store therein money such that the money cannot be fed out therefrom; a transport unit configured to move money between the storage units; and a control unit configured to perform control such that predetermined money is moved from the mixture storage unit to the collection storage unit, and to determine denominations and quantities of money with which the denomination-based storage unit and the mixture storage unit are replenished, based on a storage quantity of money in the mixture storage unit after the movement and on a storage quantity of money in the denomination-based storage unit.

In the present embodiment, a money handling method performed by a money depositing/dispensing apparatus executing a replenishment process includes: feeding out predetermined money from a mixture storage unit configured to store therein money in a denomination mixed state and storing the fed out money in a collection storage unit configured to store therein money such that the money cannot be fed out therefrom, when a denomination-based storage unit configured to store therein money for each denomination needs to be replenished with money; and determining denominations and quantities of money with which the denomination-based storage unit and the mixture storage unit are replenished, based on a storage quantity of money in the mixture storage unit after the predetermined money has been moved, and on a storage quantity of money in a denomination-based storage unit that stores therein money for each denomination.

As described above, in the money depositing/dispensing apparatus and the money handling system according to the present embodiment, when the money depositing/dispensing apparatus is to be replenished with money, money is moved from the storage unit that performs storage and feeding-out of money in the apparatus, to the collection unit for storage only, whereby the quantity of money for replenishing the money depositing/dispensing apparatus can be increased. Thus, the frequency of replenishing the money depositing/dispensing apparatus with money can be reduced.

As described above, the money depositing/dispensing apparatus, the money handling system, and the money handling method according to the present embodiment are useful for efficiently replenishing a money depositing/dispensing apparatus with money.

What is claimed is:

1. A money depositing/dispensing apparatus comprising:
a first storage configured to store therein money for each denomination;
a second storage configured to store therein money in a denomination mixed state;
a third storage configured to store therein money such that the money cannot be fed out therefrom;
a transport configured to move money between the first storage, the second storage and the third storage; and
circuitry configured to
perform control such that predetermined money is moved from the second storage to the third storage in a case that the first storage needs to be replenished with money; and
determine denominations and quantities of money with which the first storage and the second storage are replenished, based on a storage quantity of money in the second storage after the movement and on a storage quantity of money in the first storage.

2. The money depositing/dispensing apparatus according to claim 1, wherein the predetermined money is money of a predetermined denomination.

3. The money depositing/dispensing apparatus according to claim 1, wherein the predetermined money is determined based on a decrement of money, for each denomination, that has decreased in the first storage within a predetermined time period.

4. The money depositing/dispensing apparatus according to claim 1, wherein the predetermined money is determined based on a quantity of money, for each denomination, that has been moved from the second storage to the first storage within a predetermined time period.

5. The money depositing/dispensing apparatus according to claim 1, wherein the predetermined money is money of a predetermined quantity.

6. The money depositing/dispensing apparatus according to claim 1, wherein the predetermined money is money of a quantity that is obtained by multiplying a quantity of money stored in the second storage by a predetermined ratio.

7. A money handing system comprising:
a money depositing/dispensing apparatus; and
a money dispensing apparatus capable of dispensing money to be moved to the money depositing/dispensing apparatus, wherein
the money depositing/dispensing apparatus comprises
a first storage configured to store therein money for each denomination;
a second storage configured to store therein money in a denomination mixed state;
a third storage configured to store therein money such that the money cannot be fed out therefrom;
a transport configured to move money between the storages; and
circuitry configured to
perform control such that predetermined money is moved from the second storage to the third storage; and
determine denominations and quantities of money with which the first storage and the second storage are replenished, based on a storage quantity of money in the second storage after the movement and on a storage quantity of money in the first storage.

8. The money handling system according to claim 7, wherein the predetermined money is money of a predetermined denomination.

9. The money handling system according to claim 7, wherein the predetermined money is determined based on a decrement of money, for each denomination, that has decreased in the first storage within a predetermined time period.

10. The money handling system according to claim 7, wherein the predetermined money is determined based on a quantity of money, for each denomination, that has been moved from the second storage to the first storage within a predetermined time period.

11. The money handling system according to claim 7, wherein the predetermined money is money of a predetermined quantity.

12. The money handling system according to claim 7, wherein the predetermined money is money of a quantity that is obtained by multiplying a quantity of money stored in the second storage by a predetermined ratio.

13. A money handling method performed by a money depositing/dispensing apparatus executing a replenishment process, the method comprising:
feeding out predetermined money from a first storage configured to store therein money in a denomination mixed state and storing the fed out money in a second storage configured to store therein money such that the money cannot be fed out therefrom, in a case that a third storage configured to store therein money for each denomination needs to be replenished with money; and
determining denominations and quantities of money with which the third storage and the first storage are replenished, based on a storage quantity of money in the first storage after the predetermined money has been moved, and on a storage quantity of money in the third storage that stores therein money for each denomination.

14. The money method according to claim 13, wherein the predetermined money is money of a predetermined denomination.

15. The money handling method according to claim 13, wherein the predetermined money is determined based on a decrement of money, for each denomination, that has decreased in the first storage within a predetermined time period.

16. The money handling method according to claim 13, wherein the predetermined money is determined based on a quantity of money, for each denomination, that has been moved from the first storage to the third storage within a predetermined time period.

17. The money handling method according to claim 13, wherein the predetermined money is money of a predetermined quantity.

18. The money handling method according to claim 13, wherein the predetermined money is money of a quantity that is obtained by multiplying a quantity of money stored in the first storage by a predetermined ratio.
